(19) United States
(12) Patent Application Publication
(10) Pub. No.: US 2022/0052937 A1
(43) Pub. Date: Feb. 17, 2022

(54) ROBUST MONITORING OF IT INFRASTRUCTURE PERFORMANCE

(71) Applicant: LogicMonitor, Inc., Santa Barbara, CA (US)

(72) Inventors: Steve Reginald George Francis, Santa Barbara, CA (US); Jie Song, Newbury Park, CA (US)

(21) Appl. No.: 17/352,084

(22) Filed: Jun. 18, 2021

Related U.S. Application Data
(63) Continuation of application No. 15/826,522, filed on Nov. 29, 2017, now abandoned.

(51) Int. Cl. H04L 12/26; H04L 29/08; H04L 29/06; H04L 12/24

(52) U.S. Cl. CPC H04L 43/14; H04L 43/08; H04L 67/28; H04L 63/0823; H04L 41/046; H04L 63/0227; H04L 69/162

(57) ABSTRACT

There is disclosed a collector routine and process for collection of an IT infrastructure components' data characteristics including performance, availability and capacity characteristics of and events at IT infrastructure components. The collector routine cooperates with a monitor service.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to monitoring of Information Technology (IT) infrastructure components.

### Description of the Related Art

Computer networks typically include IT infrastructure components, which are the things used to develop, test, deliver, monitor, control or support IT services. People, processes and documentation are not IT infrastructure components. The primary IT infrastructure components are hardware platforms, operating system platforms, applications, data management and storage systems, and networking and telecommunications platforms. IT infrastructure components include servers, storage, networking and applications. Computer hardware platforms include client machines and server machines. Operating system platforms include platforms for client computers and servers. Operating systems are software that manage the resources and activities of the computer and act as an interface for the user. Enterprise and other software applications include software from SAP and Oracle, and middleware software that are used to link application systems. Data management and storage is handled by database management software and storage devices include disk arrays, tape libraries and storage area networks. Networking and telecommunications platforms include switches, routers, firewalls, load balancers (including the load balancers of cloud services), application delivery controllers, wireless access points, VoIP equipment and WAN accelerators. IT infrastructure includes the hardware, software and services to maintain web sites, intranets, and extranets, including web hosting services and web software application development tools.

By monitoring IT infrastructure components, administrators can better manage these assets and their performance. Performance, availability and capacity metrics are collected from the IT infrastructure components and then uploaded to a management server for storage, analysis, alerting and reporting to administrators.

Software agents have been used to collect events and metrics about IT infrastructure components. That is, an agent is installed on the IT infrastructure component, and its purpose is to monitor the IT infrastructure component. Agents have been used to monitor various aspects of IT infrastructure components, at various layers from low level hardware to top layer applications.

### DESCRIPTION OF THE DRAWINGS

FIG. 1 is a diagram of a network system.

FIG. 2 is a diagram of an IT infrastructure component having a collector routine.

FIG. 3 is a flow chart of an event collection process of a collector routine.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

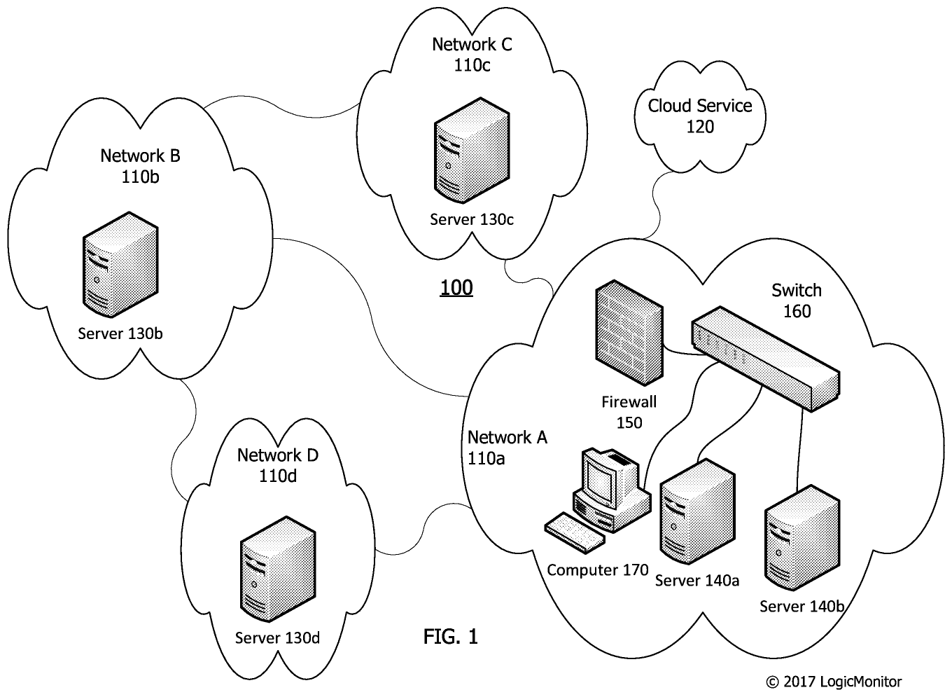

Referring now to FIG. 1 there is shown a network system 100. The network system 100 includes networks 110a, 110b, 110c, 110d and a cloud service 120, variously interconnected through the Internet as representatively shown. The system 100 may include more networks and cloud services. For example, the system 100 may include more networks akin to Network A 110a. The networks 110a, 110b, 110c and 110d may be or include a local area network. The networks 110a, 110b, 110c and 110d may have physical layers and transport layers according to IEEE 802.11, Ethernet or other wireless or wire-based communication standards and protocols. Network A includes a firewall 150, a switch 160, servers 140a, 140b and a client computer 170—all IT devices. Network A 110a may include more IT devices. One or more of the IT devices in Network A 110a may run a collector routine. Network B 110b includes a server 130b having a monitor service (not shown). Networks C and D 110c, 110d include respective servers 130c, 130d having a respective proxy (not shown).

The cloud service 120 is a computing service made available to users on demand via the Internet from a cloud computing provider's servers. The cloud service 120 provisions and provides access to remote IT devices and systems to provide elastic resources which scale up or down quickly and easily to meet demand, are metered so that the user pays for its usage, and are self-service so that the user has self-service access to the provided services.

The servers 130b, 130c, 130d, 140a, 140b are computing devices that utilize software and hardware to provide services. The servers 130b, 130c, 130d, 140a, 140b may be server-class computers accessible via the network 140, but may take any number of forms, and may themselves be groups or networks of servers.

The firewall 150 is a hardware or software based network security system that uses rules to control incoming and outgoing network traffic. The firewall 150 examines each message that passes through it and blocks those that do not meet specified security criteria.

The switch 160 is a computer networking device that connects IT devices together on a computer network by using packet switching to receive, process, and forward data from an originating IT device to a IT destination device.

The client computer 170 is shown as a desktop computer, but may take the form of a laptop, smartphone, tablet or other, user-oriented computing device.

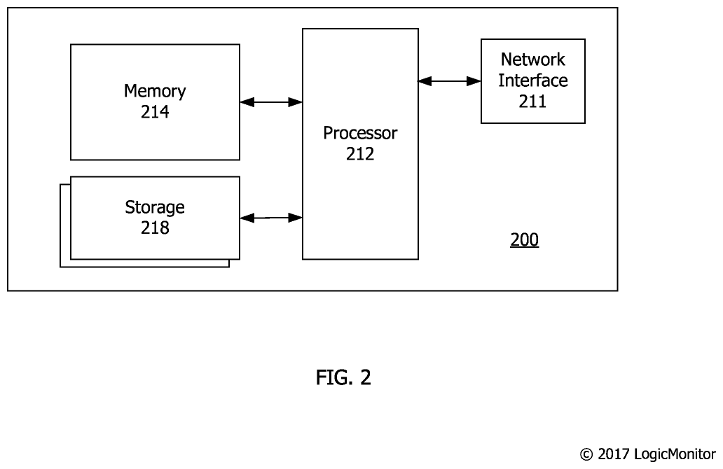

The servers 130b, 130c, 130d, 140a, 140b, firewall 150, switch 160 and client computer 170 are IT devices within the system 100, and each is a computing device as shown in FIG. 2. FIG. 2 shows a hardware diagram of a computing device 200. The computing device 200 may include software and/or hardware for providing functionality and features described herein. The computing device 200 may include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 may have a processor 212 coupled to a memory 214, storage 218, and a network interface 211. The computing device may include an I/O interface (not shown). The processor may be or include one or more microprocessors and application specific integrated circuits (ASICs).

The memory 214 may be or include one or more of RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 may provide non-volatile, bulk or long-term storage of data or instructions in the computing device 200. The storage 218 may take the form of a disk, SSD, or other reasonably high capacity addressable storage medium. Multiple storage devices may be provided or available to the computing device 200. Some of these storage devices may be external to the computing device 200, such as network storage or cloud-based storage.

The network interface 211 may be configured to interface to a network, such the networks 110a, 110b, 110c and 110d (FIG. 1).

The computing device includes software and/or hardware for providing functionality and features described herein. The computing device 200 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the computing device 200 may include various specialized units, circuits, software and interfaces for providing the functionality and features described here. The processes, functionality and features may be embodied in whole or in part in software which operates on a client computer and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a client computer and others by other devices.

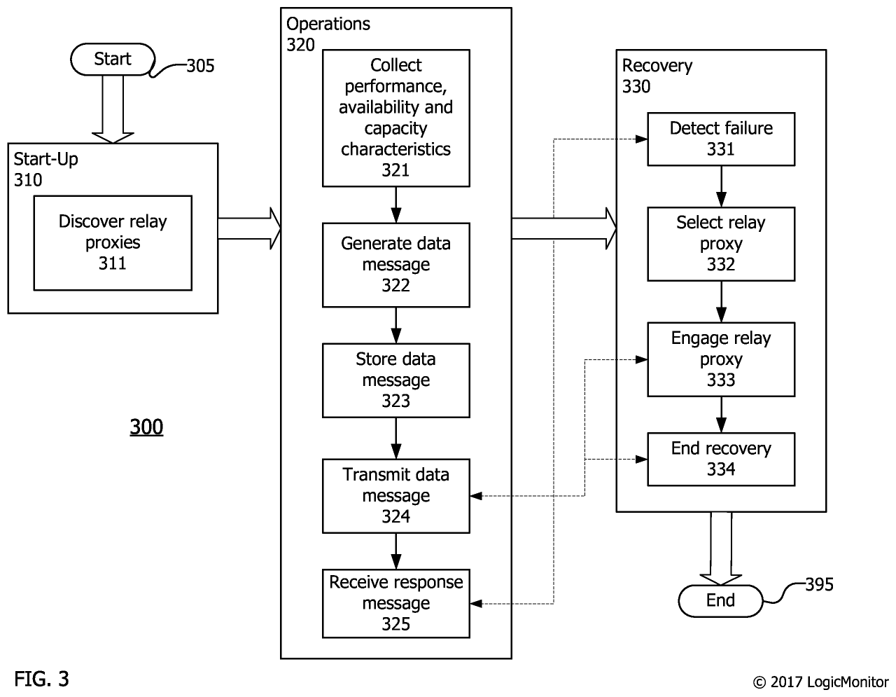

Referring now to FIG. 3, there is shown a flowchart of an event collection process 300 of a collector routine. The collector routine is agentless, meaning it collects performance metrics from an IT infrastructure component without installing any agent software on the IT infrastructure component being monitored. The collector routine accesses already existing interfaces on IT infrastructure. An agent is a software program (sometimes called a service or daemon) that runs on a computer with the primary purpose of accumulating information and making the information available in a standard format like SNMP and WMI so that it can be collected over the network from the central location. Because it is agentless, the collector routine obtains data from the software that is already installed on the IT infrastructure component, such as the operating system and previously-installed software systems. It turns out that, in many cases, there are already more than enough programs and protocols installed on a computer where the desired information can be obtained.

The event collection process 300 is computer-implemented, such that the collector routine operates in a host, namely, an IT infrastructure device such as the firewall 150, switch 160 and servers 140a, 140b, or in a virtual IT infrastructure device such as user space of a cloud service 120, and in a data network such as the system 100 shown in FIG. 1. The collector routine detects performance, availability, and capacity metrics, events and status of the host and forwards them in real time to a monitor service running in a server such as the server 130b (FIG. 1) which is remote from the host. The collector routine connects to the monitor service through an outbound port, optionally using a HTTP proxy, and creates a bi-directional socket for communication to the remote server running the monitor service. Data is buffered locally in the collector, and sent in real time as the network capacity and throughput allows. The collector verifies the identity of the monitored service using TLS Certificates. The monitored service identifies the identity of the collector routine using rotating credentials.

Although described herein as a one-to-one relationship between the monitor service and the collector routine, the monitor service may support a one-to-many model, with the collector routine running in multiple hosts. In the one-to-many model, the monitor service may support user accounts, with hosts assigned to the user accounts. Accordingly, a user may utilize the monitor service to manage physically and/or logically grouped hosts. For example, referring again to FIG. 1, one user account includes the IT infrastructure devices in Network A together with the cloud service 120, another user account includes IT infrastructure devices in Network C, and yet another user account includes IT infrastructure devices in Network D. User accounts may include hosts in other user accounts.

The monitor service consolidates the information about the hosts provided by the respective collector routines, thereby allowing a user to have visibility into the status and the performance of individual hosts and groups of hosts. With the event collection process running on multiple hosts, the event collection process will operate concurrently on those hosts, and the monitor service continuously consolidating the data from the hosts.

Cooperation between the collector routine and the monitor service may provide full data center visibility. The monitor service may provide complete visibility into cloud services such as Amazon Web Services (AWS). The monitor service may combine AWS CloudWatch metrics, synthetic transactions and custom metrics with visibility into on-premises infrastructure for a complete view into hybrid environments. Thus, an array of things may be automatically monitored: active interfaces, BGP sessions, CPUs, memory pools, temperature sensors, modules and cards, respective CPU and memory, QoS policies, IP SLA profiles, VoIP specific features, ESX hosts, datastores, virtual machines, resource pools, VMware environment, operating systems of virtual machines, applications running on virtual machines (including IIS, MySQL, Apache), storage arrays, session statistics for ICMP, TCP and UDP protocols, percentage of total sessions actively used, session utilization, SSL sessions and capacity, active interfaces, CPU usage, disk activity, IO per second, cache age, consistency point activity, per volume space, inode and snapshot utilization, per volume read and write latency, IO operations per second and throughput, disk, fan and power supply failures, autosupport success, LUN queue depth, and network traffic flows including Netflow, J-Flow, and S-Flow.

This arrangement allows an administrator to determine exactly where network problems originate and to therefore proactively manage challenging network conditions such as congestion and over-consumption of network resources. The monitor service may support measurement, visualization and alerting on availability and performance of websites through multiple steps, from multiple locations around the globe. The monitor service may support tracking of site performance from multiple locations around the world or from within private networks. The monitor service may support confirmation that monitored websites are up and accessible from one or multiple external test locations, or from within a selected network. The monitor service may support multi-step tests that handle authentication and check for specific content in responses. The monitor service may support making HTTP GET, HEAD, or POST requests to multiple URLs and confirming that the correct web page is loaded. The monitor service may ping an IP address from one or more external locations. The monitor service may collect and manage network device configurations, and correlate changes with performance impacts. The monitor service may generate alerts, for example using default thresholds or thresholds tuned on a global, group or object level.

The event collection process 300 includes a start-up process 310, an operations process 320 and a recovery process 330. The flowchart has both a start 305 and an end 395, but the event collection process 300 is cyclical in nature.

If the collector routine experiences certain kinds of problems when communicating with the monitor service, the collector routine can use an alternate path to the monitor service, such as through proxies operating in servers 130c, 130d (FIG. 1). The proxy may be a Tomcat-based application or other Java-based servlet, script or application which gets requests from the collector routine, forward them to the monitor service, and forward responses from the monitor service to the collector routine.

The collector routine connects to the proxy through an outbound port and creates a bi-directional socket for communication to the server running the proxy. The collector routine can then communicate with the monitor service by sending traffic to the proxy. The proxy then relays the messages to the monitor service through a bi-directional socket dedicated to each collector routine. Thus, the collector routine does not need a direct connection to the monitor service.

During the start-up process 310, the collector routine performs a discovery operation 311 to discover available proxies. When the relay connection is established, the collector routine can exchange messages with the monitor service via the proxy.

In the operations process 320, the collector routine performs its ordinary operations. Within the operations process 320, there are a number of sub-processes which the collector routine performs continuously.

In step 321, the collector routine collects performance, availability and capacity metrics about the host, as well as collecting events about the host. Host events may include system events recorded in system event logs; detecting the presence of strings in log files; changes in data reported by IPMI; SNMP traps; etc. The set of performance, availability and capacity measurements collected for each host may vary with the type of host, and with the hosts configured set of features and capabilities. For example, for most hosts, the collector will collect CPU utilization measurements. If the host has one or more file storage systems or hard drives, the collector routine will collect total space and utilized space of those file systems or hard drives. If the host has a message transfer agent, the collector routine will collect message queue data, as well as the availability of the message transfer agent. If a host if reconfigured to support a new feature (for example, if a new routing protocol such as OSPF is enabled on the host), the collector routine may discover the new configuration, and commence to monitor the new feature. In the example of OSPF, it would monitor the OSPF adjacencies, and the status of the routing protocol.

Discovery of which performance, availability and capacity metrics to collect may be triggered by an instruction sent from the monitoring system to the collector routine, which reports back data, which the monitor service then classifies to get more questions to ask, which the collector does, and reports back, which then makes the monitor service tell the collector what performance, availability and capacity data to collect.

In step 322, the collector routine generates a data message from the performance, availability and capacity characteristics accessed. In step 323, the collector routine stores the data message in a persistent, time-framed buffer. In step 324, the collector routine transmits the data message to the monitor service. In step 325, the collector routine receives a response message from the monitor service in response to receipt of the transmitted data message.

The collector routine 300 may manage the buffer in a number of ways. The collector routine may remove each data message from the buffer upon its transmission to the monitor service (step 324), or upon confirmation of its receipt (step 325). The collector routine may also remove data messages from the buffer if they are older than a specified age, and/or when the buffer reaches a predefined fill condition, such as completely or nearly full.

In the recovery process 330, the collector routine recovers from transmission failures in the operation process 320, facilitated by interprocess interactions between the recovery process 330 and the operation process 320. In step 331 transmission failure is detected. To achieve this, the recovery process 330 may communicate with the operation process 320, and/or monitor the buffer. For this reason, in FIG. 3 a dashed line is shown between steps 331 and 325. Thus, failure may be detected by a lack of a receipt in step 325, by a data message remaining in the buffer for too long, or the buffer reaching a fill state reflective of a predefined number of data messages remaining in the buffer after they were expected to be removed based upon a successful transmission. Failure may be determined based upon how a single data message was handled in the operation process 320, or from a predetermined (system defined or user configurable) number of data messages. The collector routine may attempt to transmit a given data message some (system defined or user configurable) number of times to the monitor service before it concludes that there was a failure. The collector routine may use a thread to keep track of the monitor service and the selected proxy, when engaged.

In step 332, a proxy is selected. If there is a pool of known proxies, one may be selected from the pool based upon one or more factors, such a proximity to the host, reliability of the proxy, a random choice, a fixed priority order, availability at the time of need, and ability to communicate with the monitor service.

In step 333, the collector routine engages the proxy. This may be performed by the recovery process 330 instructing the operation process 320 to use the proxy when transmitting in step 324. For this reason, in FIG. 3 a dashed line is shown between steps 333 and 324. Thereafter, the collector routine transmits subsequent data messages to the proxy for re-transmission to the monitor service. The operation process 320 may also re-transmit the failed data message or messages, as the case may be, if available in the buffer. Thus, the collector routine receives response messages from the selected proxy originating from the monitor service in response to receipt by the monitor service of each transmitted data message.

Engagement of a proxy does not guarantee successful transmission to the monitor service. Thus, after a proxy has been engaged, the recovery process 330 is used to detect and recover from failure of transmission of data messages via the proxy.

In step 334, the collector routine ends the recovery process 330. That is, after re-establishing a connection with the monitor service, the collector routine restarts transmission to the monitor service instead of using the proxy. For this reason, in FIG. 3 a dashed line is shown between steps 334 and 324. The collector routine may determine through various techniques that direct communication with the monitor service is available. For example, the collector routine may send test messages to the monitor service and conclude that the monitor service is available upon receipt of a response from the monitor service. The collector routine may switch back to the monitor service if the communication with the monitor service succeeds for a predetermined period of time, and/or after a (system defined or user configurable) predetermined number of data messages have been sent through the proxy. The predetermined period of time and predetermined number when system defined may be fixed or dynamic, e.g., based upon variables known to the collector routine.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A computer-implemented method, operable in a data network and operable on a host comprising hardware including memory and at least one processor, the data network comprising a plurality of computers, each computer comprising hardware including memory and at least one processor, the method comprising, by a collector routine operating in the host:
an operations process:
on a continuous basis, assessing data characteristics of the host by the collector routine operating in a host,
on a continuous basis, the collector routine generating data messages from the data characteristics as assessed,
on a continuous basis, the collector routine storing the health messages as generated in a persistent, time-framed buffer,
on a continuous basis, the collector routine transmitting each health message as stored to a predefined monitor service, and
on a continuous basis, the collector routine receiving response messages from the monitor service in response to receipt of each transmitted health message;
a recovery process:
on a continuous basis, the collector routine sensing failed transmission to the monitor service and thereafter transmitting subsequent data messages via a socket configured for communication with a selected proxy, the subsequent data messages being for re-transmission via another socket configured for communication by the selected proxy to the monitor service, and
on a continuous basis, the collector routine receiving response messages from the selected proxy originating from the monitor service in response to receipt by the monitor service of each re-transmitted data message.

2. The method of claim 1 further comprising the collector routine, during a start-up process, performing a discovery operation to discover available proxies.

3. The method of claim 2 further comprising, in the recovery process when the collector routine needs to transmit to a proxy, the collector routine selecting from the available proxies comprising a random selection and testing of the randomly selected proxy for its capability at that time to transmit data messages to the monitor service.

4. The method of claim 1 further comprising, during the recovery process, the collector routine ending the recovery process after re-establishing a connection with the monitor service.

5. The method of claim 1 further comprising on a continuous basis, the collector routine removing each data message from the buffer upon its successful transmission to at least one of the monitor service or the selected proxy.

6. The method of claim 1 further comprising the collector routine restarting transmission to the monitor service.

7. The method of claim 1 wherein the host comprises one of a server, a storage device, a networking device and an application.

8. The method of claim 1 further comprising the collector routine removing from the buffer health message older than a specified age.

9. The method of claim 1 further comprising, in the recovery process, the collector routine re-transmitting health messages which were subject of a prior transmission failure.

10. The method of claim 1 further comprising discontinuing use of the proxy and recommencing communications with the monitor service without the proxy.

11. The method of claim 1 wherein the data characteristics include a performance, availability and capacity characteristics.

12. A computer program product having computer readable instructions stored on non-transitory computer readable media, the computer readable instructions including instructions for implementing a collector routine as an agentless computer-implemented method in a host, the method comprising
an operations process:
on a continuous basis, assessing data characteristics of the host by the collector routine operating in a host,
on a continuous basis, the collector routine generating health messages from the data characteristics as assessed,
on a continuous basis, the collector routine storing the data messages as generated in a persistent, time-framed buffer,
on a continuous basis, the collector routine transmitting each data message as stored to a predefined monitor service, and
on a continuous basis, the collector routine receiving response messages from the monitor service in response to receipt of each transmitted data message;
a recovery process:
on a continuous basis, the collector routine sensing failed transmission to the monitor service and thereafter transmitting subsequent data messages via a socket configured for communication with a selected proxy, the subsequent data messages being for re-transmission via another socket configured for communication by the selected proxy to the monitor service,
on a continuous basis, the collector routine receiving response messages from the selected proxy originating from the monitor service in response to receipt by the monitor service of each re-transmitted data message, and
on a continuous basis, the collector routine re-transmitting data messages which were subject of a prior transmission failure.

13. The computer program product of claim 12 further comprising the collector routine, during a start-up process, performing a discovery operation to discover available proxies.

14. The computer program product of claim 13 further comprising, in the recovery process when the collector routine needs to transmit to a proxy, the collector routine selecting from the available proxies comprising a random selection and testing of the randomly selected proxy for its capability at that time to transmit data messages to the monitor service.

15. The computer program product of claim 12 further comprising, during the recovery process, the collector routine ending the recovery process after re-establishing a connection with the monitor service.

16. The computer program product of claim 12 further comprising on a continuous basis, the collector routine removing each data message from the buffer upon its successful transmission to at least one of the monitor service or the selected proxy.

17. The computer program product of claim 12 further comprising the collector routine restarting transmission to the monitor service.

18. The computer program product of claim 12 wherein the host comprises one of a server, a storage device, a networking device and an application.

19. The computer program product of claim 12 further comprising the collector routine removing from the buffer data messages older than a specified age.

20. The computer program product of claim 12 further comprising, in the recovery process, the collector routine re-transmitting data messages which were subject of a prior transmission failure.

21. The computer program product of claim 12 further comprising discontinuing use of the proxy and recommencing communications with the monitor service without the proxy.

22. The computer program product of claim 12 wherein the data characteristics include performance, availability and capacity characteristics.
